(19) United States
(12) Patent Application Publication
(10) Pub. No.: US 2017/0238551 A1
(43) Pub. Date: Aug. 24, 2017

(54) HERBAL COMPOSITIONS AND METHOD FOR PREPARING THEREOF

(71) Applicant: Yunnan Panlong Yunhai Pharmaceutical Co. Ltd., Kunming (CN)

(72) Inventors: Yang Cao, Suzhou (CN); Li Hua Zeng, Macau (CN)

(73) Assignee: Yunnan Panlong Yunhai Pharmaceutical Co. Ltd, Kunming (CN)

(21) Appl. No.: 15/407,171

(22) Filed: Jan. 16, 2017

Related U.S. Application Data
(60) Provisional application No. 62/389,170, filed on Feb. 19, 2016.

(51) Int. Cl. A01N 61/00

(52) U.S. Cl. CPC A01N 61/00

(57) ABSTRACT

The present invention relates to herbal compositions and method for preparing thereof. The herbal composition is derived from pulverizing at least two herbal materials selected from a group of herbal materials consisting of Panax ginseng, Glycyrrhiza uralensis, Agrimonia pilosa, Gynostemma pentaphyllum, asparagus, and mushroom. The pulverized herbal materials are combined to obtain a mixed herbal powder which is then extracted with a solvent to obtain a concentrated herbal extract, wherein the concentrated herbal extract is dried to obtain a dry powder of the herbal compositions.

### CROSS REFERENCE TO RELATED APPLICATIONS

This application claims the benefit of U.S. Provisional Application No. 62/389,170, filed Mar. 11, 2016. The entire disclosure of this prior application is hereby incorporated by reference.

### FIELD OF THE INVENTION

The present disclosure relates to herbal compositions and method for preparing thereof.

### BACKGROUND OF THE INVENTION

Ginseng has been used as a medicine for over two thousand years. Currently, approximately 6 million Americans use it regularly. Panax ginseng is often referred to as a general well-being medication, because it affects many different systems of the body. It is used for improving general well-being of the body and functions, such as thinking, concentration, memory and work efficiency, physical stamina, and athletic endurance. It is also used for treating depression, anxiety, chronic fatigue syndrome (CFS); for boosting the immune system; and for fighting particular infections in a lung disease called cystic fibrosis. It is also known that some people use Panax ginseng to treat breast cancer and as a preventive medicine for ovarian cancer, liver cancer, lung cancer, and skin cancer. Other uses of Panax ginseng include treatment of anemia, diabetes, inflammation of the stomach lining (gastritis), fever, hangover, chronic obstructive pulmonary disease (COPD), asthma, bleeding disorders, loss of appetite, vomiting, intestinal problems, fibromyalgia, sleeping problems (insomnia), nerve pain, joint pain, dizziness, headache, convulsions, disorders of pregnancy and childbirth, hot flashes due to menopause, and to slow the aging process. Some men use Panax ginseng on the skin of the penis as part of a multi-ingredient product for treating early orgasm (premature ejaculation). Men also use it for erectile dysfunction (ED).

In Western medicine, Panax ginseng is used as a stimulant to make people more active. On the contrary, in Traditional Chinese Medicine (TCM), Panax ginseng is used to make people feel calmer. It is also widely used in China for the heart and blood vessels. Panax ginseng contains many active substances and the substances thought to be most important are called ginsenosides or panaxosides.

The common name of Glycyrrhiza uralensis is Liquorice root/licorice. Liquorice root contains glycyrrhizin and many flavones, such as liquiritin, neoliquirtin, isoliquiritin and isoliquiritigenin; and also hydrolytes such as glucuronic acid and glycyrrhetinic acid. In TCM, Liquorice root replenishes qi (vital energy), facilitates spleen and stomach functioning, clears heat, eliminates toxic substance, expels phlegm, controls coughing, slows down acute reactions, stops pain and modulates the harsh properties of other herbs.

Agrimonia pilosa is also named as Xian He Cao, Herba et Gemma Agrimoniae, Hairyvein Agrimonia Herb and Bud. In general, the plant is used in the treatment of abdominal pain, sore throat, headaches, bloody and mucoid dysentery, bloody and white discharge, heat-stroke, parasitic worms, bois, ezema, coughs, colds, tuberculosis and diarrhoea. Its stems and leaves are analgesic, antibacterial, anti-inflammatory, antipyretic, astringent, cardiotonic, haemostatic, hypoglycaemic, taenicidal and vasoconstricting. The leaves are also rich in vitamin K; thus, they are used to promote blood clotting and control bleeding. The plant contains many active substances. One of these active substances is agrimonin which is haemostatic, cardiotonic and blood-sugar lowering. The root juice of the plant is also used in the treatment of peptic ulcer.

Gynostemma pentaphyllum is also known as “Southern Ginseng” as it contains large quantities of gypenosides. A large series of dammarane triterpene saponins and gypenosides 1-82 have been isolated from its leaves. Several of these saponins are identical to those found in ginseng. For example, gypenoside 3 is identical to ginsenoside Rb1; gypenoside 4 is identical to ginsenoside Rb3; gypenoside 8 is identical to ginsenoside Rd; gypenoside 12 is identical to ginsenoside F2. Many of the other gypenosides are closely related structurally to the ginsenosides and include the 6′-malonyl derivatives characteristic of ginseng. The content of saponins is comparable to that of ginseng roots. Studies on Gynostemma have found that the plant is effective in regulating blood pressure, strengthening the immune system, lowering cholesterol, and in increasing stamina and endurance properties. Gynostemma has also been found to have hyperlipidemic, lipid peroxidation, adaptogenic, anticancer, cardio- and cerebrovascular effects.

Asparagus is a genus in Asparagaceae family. The newly formed shoots (spears), root, and “underground stems” (rhizomes) are used to make medicine. Asparagus is commonly used along with lots of fluids as “irrigation therapy” to increase urine output. It is also used to treat urinary tract infections and other conditions of the urinary tract that cause pain and swelling. Other uses include treatment of joint pain (rheumatism), hormone imbalances in women, dryness in the lung and throat, constipation, nerve pain (neuritis), AIDS, cancer, and diseases caused by parasites. It is also used for preventing stones in the kidney and bladder and anemia due to folic acid deficiency. Since ancient time, its health benefits have been acknowledged and its use was not limited as a cough medicine. The “Compendium of Materia Medica” states that the preserved asparagus in alcohol is an anti-aging beauty product that can tonify the five Zang-organs, regulate the six Fu-organs, and thereby protect the drinkers from illness; Sheng Ji Zong Lu (Complete Record of Holy Benevolence) reviews that its ground powder is an impressive facial cleanser, which helps in skin whitening. In Chinese herbal remedies, “Er Dong” (Two Dong) is the common ingredient, which literally is the abbreviation for Tian Men Dong (Pinyin of Asparagus roots) and Mai Men Dong (Ophiopogon, Monkey Grass). They are often put together for the treatment of intestinal dryness with constipation because they have similar healing properties—nourishing lung-stomach yin, moistening lung dryness, clearing lung-stomach heat, helping saliva production, and quenching thirst. Another important reason they need each other is that they can mutually promote the efficacy based on their differences. Asparagus is more bitter and cold in nature, which makes it possess more powerful ability on clearing fire and moistening dryness. In addition, since it acts on kidney and nourishes Yin, it is also appropriate for syndromes of kidney-yin deficiency and the hyperactivity of deficient fire. In comparison, monkey grass is slightly cold and with weaker power of clearing fire and moistening dryness. Monkey grass is more easily digested and absorbed. Monkey grass is good for clearing heart heat to relieve restlessness, and calming heart to tranquilize mind. Monkey grass is especially fit for syndromes of heart-yin deficiency and the hyperactivity of heart heat. These two herbs have not only similar name, but also similar medicinal uses; hence, clinically they are a perfect match for nourishing Yin and moistening lung.

Asparagine found in Asparagus has certain effects on relieving asthma, suppressing coughing, and promoting expectoration; asparagine can result in peripheral vasodilation, lowering blood pressure, enhancing cardiac contractility, decreasing heart rate and increasing urine output; it can increase peripheral white blood cell count, enhance the phagocytotic ability of reticuloendothelial system, and boost humoral immunity; its decoction and alcohol extract can promote antibody production, prolong the survival time of the antibody, prevent mutations in experimental animals' cells, increase cAMP levels in tumor cells, and inhibit the proliferation of tumor cells. In vitro tests has shown different degrees of growth inhibition on alpha hemolytic streptococcus, beta hemolytic streptococcus, Corynebacterium diphtheriae, Streptococcus pneumoniae, Staphylococcus aureus, and more.

For thousands of years in the Orient, mushrooms have been revered as longevity-promoting tonics as well as being used in herbal medicine. Whilst anecdotal evidence and folk medicine are testimony to the health benefits of edible mushrooms, clinical studies now offer substantial proof that medicinal mushrooms can offer real therapeutic healing. While much attention in recent years has focused on various immunological and anti-cancer properties of certain mushrooms, mushrooms also offer other potentially important health benefits, including antioxidants, anti-hypertensive and cholesterol-lowering properties, liver protection, as well as anti-inflammatory, anti-diabetic, anti-viral and anti-microbial properties. These properties have attracted the interest of many pharmaceutical companies, which are viewing the medicinal mushroom as a rich source of innovative biomedical molecules.

Since these herbal plants have such important medicinal values, they can be used in various combinations to achieve different clinical effects. The preparation of these herbal extracts must be carefully controlled so that the desirable active ingredients can be extracted and combined. Chemical solvents, such as alcohol and methanol, can be used to extract the active ingredients from these plants. Temperature and time control during the extraction procedure can have profound effects on the ingredients being isolated. The various “cooking” times recommended for different Chinese herbs represent a balance between two major considerations: the time it takes for extraction of active components from the crude herbs and the rate of loss of active components by heat, oxidation, decomposition, and evaporation. When fresh vegetables are steamed or boiled, the color of the vegetables becomes brighter after just a few minutes; however, they discolor and lose both taste and nutritional value after a few more minutes. Furthermore, herbs can be “over-cooked” leading to over-reaction with the solvent thereby destructing medicinal value of the herb extracts. Sometimes, prolonged cooking with a solvent at a specific range of temperature is recommended when the destruction of active components is deemed desirable. For example, raw aconite is cooked for several hours to render it essentially non-toxic.

The preparation of herbs under a complex formula is very challenging. Whether the herbs should be pulverized or simply cut into small pieces before extraction can significant affect the final medicinal value. For example, in order for several herbs belonging to a complex formula to be effectively cooked in about the same amount of time, they may need to be cut to the appropriate thickness. The thickness of the herbs influences the time it takes for the active components to migrate from the middle of the herb material to the water medium. The slicing that is usually done before Chinese herbs renders most herbs relatively thin, so that these different herbs can be cooked for about the same amount of time (and a much shorter time than if they were uncut). Thick roots such as ginseng and tang-kuei are sometimes sold in whole form, but are best used after being sliced so that their thickness is comparable with other ingredients. Hard roots (e.g., tienchi) and barks (e.g., phellodendron) need to be thinner than soft fruits (e.g., lycium and chaenomeles).

These six herbal materials, i.e. Panax ginseng, Glycyrrhiza uralensis, Agrimonia pilosa, Gynostemma pentaphyllum, asparagus and mushroom, can be combined in various combinations and proportions, to achieve different medical effects, such as supporting the body's natural balance and tonifying the deficiency, clearing away the heat-evil and expel superficial evils, benefiting vital energy and dissolving the stagnant. Such herbal compositions may also be used to treat various cancers and assist treatment of radiotherapy, chemotherapy and after-treatment. However, the preparation process must be optimized so that the desired medical effects are preserved, when these herbal materials are put through the manufacturing process in various combinations and proportions.

Still another purpose of the present invention describes a method to concentrate the active principles of the herbal materials into granular form product for easy consumption.

### SUMMARY OF THE INVENTION

Embodiments of the present disclosure provide a process for preparing a herbal composition comprising pulverizing at least two herbal materials, wherein the at least two herbal materials comprise herbal materials selected from the group consisting of Panax ginseng, Agrimonia pilosa, Glycyrrhiza uralensis, Gynostemma pentaphyllum, asparagus and mushroom; combining the pulverized herbal materials to obtain a mixed herbal powder; extracting the mixed herbal powder with a solvent to obtain a herbal extract; concentrating the herbal extract, wherein the concentrated herbal extract has a density of from about 0.2 g/cm³ to about 2 g/cm³; and drying the herbal extract to obtain the herbal composition.

Certain embodiments provide a process for preparing a herbal composition comprises a mixture of herbal materials, wherein the mixture of herbal materials comprises Panax ginseng, Glycyrrhiza uralensis, Agrimonia pilosa, Gynostemma pentaphyllum, asparagus and mushroom; pulverizing herbal materials; combining the pulverized herbal materials to obtain a mixed herbal powder; extracting the mixed herbal powder with a solvent to obtain a herbal extract; concentrating the herbal extract to obtain a concentrated herbal liquid, wherein the concentrated herbal liquid has a density of from about 0.8 g/cm³ to about 1.5 g/cm³; loading the concentrated herbal liquid on a fluidized bed; and spray drying the herbal liquid to obtain the herbal extract composition.

### DESCRIPTION OF FIGURE

FIG. 1 is a flowchart showing steps of the exemplary method of the invention.

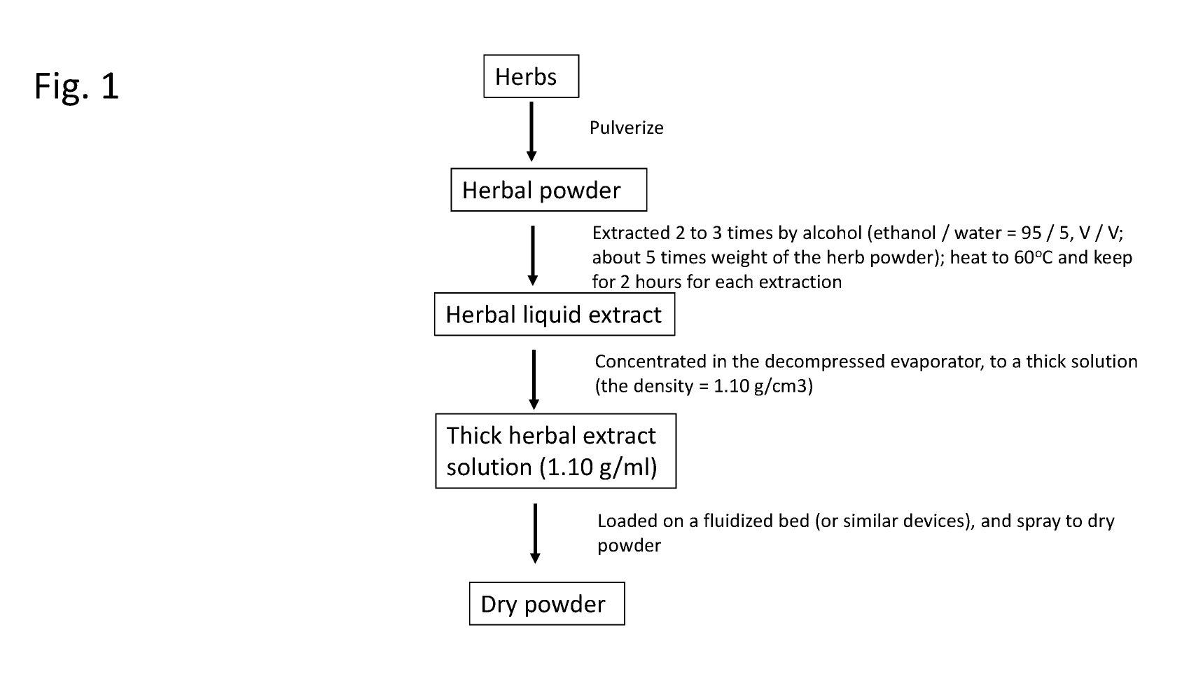

### DETAILED DESCRIPTION OF THE INVENTION

In this specification and the appended claims, the singular forms “a,” “an” and “the” include plural reference unless the context clearly dictates otherwise.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

The term “herbal,” as used herein, refers to plant substances or products of natural origin, in approximately the concentration as found in nature, and similar variations and modifications, and the like. The herbal materials may be fresh, freshly-dried, or dried. The part of the plant used as the herbal materials of the present embodiments may vary. The present process may use some or all parts of the targeted plant, including flowers, leaves, stems, and roots combined.

Examples of the herbal materials of the present disclosure include, but are not limited to, Panax ginseng; Gynostemma pentaphyllum (often called as Southern ginseng); Glycyrrhiza uralensis; Agrimonia pilosa; asparagus, such as Asparagus officinalis, Asparagus racemosus; mushroom, such as Ganoderma lucidum, Poria cocos, Cordyceps sinensis, Polyporus umbellatus, Auricularia auricula, Lentinus edodes and Hericium erinaceus; and mixtures thereof.

The herbal composition of the present embodiments may include two, three, four or more herbal materials. In certain embodiments, the herbal composition includes at least two herbal materials, at least three herbal materials, at least four herbal materials, or at least five herbal materials. In certain embodiments, the herbal composition includes Panax ginseng and Gynostemma pentaphyllum. In certain embodiments, the herbal composition include Glycyrrhiza uralensis and Agrimonia pilosa. In certain embodiments, the herbal composition includes Panax ginseng, Gynostemma pentaphyllum and Glycyrrhiza uralensis. In certain embodiments, the herbal composition includes Panax ginseng, Gynostemma pentaphyllum and asparagus. In certain embodiments, the herbal composition includes Panax ginseng, Gynostemma pentaphyllum and mushroom. In certain embodiments, the herbal composition includes Panax ginseng, asparagus and mushroom. In certain embodiments, the herbal composition includes asparagus, mushroom and Glycyrrhiza uralensis. In certain embodiments, the herbal composition includes Gynostemma pentaphyllum, asparagus and mushroom. In certain embodiments, the herbal composition includes Panax ginseng, Gynostemma pentaphyllum, and Agrimonia pilosa. In certain embodiments, the herbal composition includes Panax ginseng, Gynostemma pentaphyllum, Glycyrrhiza uralensis and Agrimonia pilosa. In certain embodiments, the herbal composition includes Panax ginseng, Gynostemma pentaphyllum, Glycyrrhiza uralensis and asparagus. In certain embodiments, the herbal composition includes Panax ginseng, Gynostemma pentaphyllum, Glycyrrhiza uralensis and mushroom. In certain embodiments, the herbal composition includes Panax ginseng, Gynostemma pentaphyllum, asparagus and mushroom. In certain embodiments, the herbal composition includes Panax ginseng, asparagus, Glycyrrhiza uralensis and Agrimonia pilosa. In certain embodiments, the herbal composition includes Panax ginseng, mushroom, Glycyrrhiza uralensis and Agrimonia pilosa. In certain embodiments, the herbal composition include asparagus, Gynostemma pentaphyllum, Glycyrrhiza uralensis and Agrimonia pilosa. In certain embodiments, the herbal composition includes mushroom, Gynostemma pentaphyllum, Glycyrrhiza uralensis and Agrimonia pilosa. In certain embodiments, the herbal composition includes Panax ginseng, Gynostemma pentaphyllum, Glycyrrhiza uralensis, Agrimonia pilosa and asparagus. In certain embodiments, the herbal composition includes Panax ginseng, Gynostemma pentaphyllum, Glycyrrhiza uralensis, Agrimonia pilosa and mushroom. In certain embodiments, the herbal composition includes Panax ginseng, Glycyrrhiza uralensis, Agrimonia pilosa, Gynostemma pentaphyllum, asparagus and mushroom.

The herbal materials may be pulverized individually (i.e., pulverize one herbal material and not mixed with other herbal materials), or may be pulverized with one or more herbal materials. The pulverized herbal materials may be combined together to obtain a mixed herbal powder.

Based on the total weight of the mixed herbal powder (dry powder), Panax ginseng may be present in an amount of from about 1% to about 60%, from about 10% to about 40%, from about 15% to about 25%, or from about 21% to about 23%; Glycyrrhiza uralensis may be present in an amount of from about 1% to about 60%, from about 10% to about 40%, from about 15% to about 25%, or from about 20% to about 25%; Agrimonia pilosa may be present in an amount of from about 1% to about 60%, from about 1% to about 40%, from about 1% to about 30%, from about 5% to about 15%, or from about 9% to about 11%, Gynostemma pentaphyllum may be present in an amount of from about 1% to about 60%, from about 5% to about 35%, from about 10% to about 25%, or from about 16% to about 18%; asparagus may be present in an amount of from about 1% to about 60%, from about 10% to about 40%, from about 15% to about 25%, or from about 22% to about 24%; mushroom may be present in an amount of from about 1% to about 60%, from about 1% to about 40%, from about 1% to about 10%, or from about 6% to about 8%.

The mixed herbal powder is subjected to an extraction with ethanol/water mixture. The ratio of the alcohol to water may be from about 80:20 to about 99:1, from about 90:10 to about 98:2, from about 95:5 to about 97:3 by volume. The mixed herbal powder may extracted several tines, e.g., 2-3, 2-4, 2-5 or more times with the extraction solvent to obtain a herbal extract. The weight ratio of the extraction solvent to the mixed herbal powder may be in the range of from about 2 to about 8, from about 3 to about 7, or from about 4 to about 6. The temperature of the herbal extract may be increased from about 40° C. to about 100° C., such as from about 55° C. to about 60° C. Such elevated temperature may be maintained for, from about 0.1 to about 5 hours, from about 0.5 to about 4 hours, or from about 1 to about 3 hours.

Subsequently, the herbal extract may be concentrated down to obtain a concentrated herbal liquid. The concentrated herbal liquid may have a density of from about 0.2 g/cm³ to about 2 g/cm³, 0.5 g/cm³ to about 1.5 g/cm³, or 1.0 g/cm³ to about 1.2 g/cm³.

Drying of the concentrated herbal extract may be carried out by any conventional drying method, such as but not limited to, drying under reduced pressure, spray drying (atomization), and freeze drying or lyophilization. Spray drying technique is a transformation of feed from a fluid state into dried particulate form by spraying the feed into a hot drying medium. It is a continuous particle-processing drying operation. The feed can be a solution, suspension, dispersion, emulsion or slip. Spraying drying can be coupled with a fluidized bed. The concentrated herbal liquid may be loaded onto a fluidized bed for drying, and then further spray dried to obtain the herbal composition. The concentrated herbal liquid passing through the fluidized bed becomes coarser and free flowing, making it much easier for spray drying. The reason for better flow ability is a partial agglomeration.

The herbal composition of the present disclosure nay be in solid form, which may be in dry powders, granules, or agglomerates. The herbal composition may be placed into capsules or tablets.

The following examples are for the purpose of illustration of the embodiments only and are not intended in any way to :limit the scope of the disclosure.

### EXAMPLES

### Example 1

Six herbs, Panax ginseng, Glycyrrhiza uralensis, Agrimonia pilosa, Gynostemma pentaphyllum, asparagus and mushroom were carefully cleaned and ground respectively. The powders were well blended basing on the ratio of weight, 22.0%, 20.3%, 10.0%, 17.0%, 23.0% and 7.7% respectively. The blended herb powder was extracted 2 to 3 times by alcohol solution (ethanol/water=95/5, v/v). The alcohol solution was added at 5 times weight of the blended herb powder. The mixture was then heated to 60° C. for 2 hours. The extract solutions were filtrated, and combined together. The combined extract solution was concentrated in a decompressed evaporator, to a thick solution at the density of about 1.10 g/cm³. This thick solution was loaded on a fluidized bed (or similar devices), and spray to dry powder. The herbs extract powders were accurately weighed, and packed to final products. The reference data of fluidized bed was as following:

Speed of rotary plate: 20000 R/min.

Speed of rotary plate: 20000 R/min.

Temperature of inlet air: 210-250° C.

Temperature of outlet air: 80-90° C.

Flow rate of solution: 90-150 ml/min.

Sieving mesh: 80 mesh.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

What is claimed is:

1. A process for preparing a herbal composition comprising:
a. pulverizing at least two herbal materials, wherein the at least two herbal materials comprise herbal materials selected from the group consisting of Panax ginseng, Agrimonia pilosa, Glycyrrhiza uralensis, Gynostemma pentaphyllum, asparagus and mushroom;
b. combining the pulverized herbal materials to obtain a mixed herbal powder;
c. extracting the mixed herbal powder with a solvent at certain temperature for a certain period of time to obtain a herbal extract;
d. concentrating the herbal extract, wherein the concentrated herbal extract has a density of from about 0.2 g/cm³ to about 2 g/cm³; and
e. drying the herbal extract to obtain the herbal composition.

2. The process of claim 1, wherein each of the herbal materials is pulverized individually.

3. The process of claim 1, wherein all herbal materials are mixed and pulverized.

4. The process of claim 1, wherein Panax ginseng is present in an amount from about 1% to about 60% by weight based on the weight of the mixed herbal powder.

5. The process of claim 1, wherein Glycyrrhiza uralensis is present in an amount from about 1% to about 60% by weight based on the weight of the mixed herbal powder.

6. The process of claim 1, wherein Agrimonia pilosa is present in an amount from about 1% to about 60% by weight based on the weight of the mixed herbal powder.

7. The process of claim 1, wherein Gynostemma pentaphyllum is present in an amount from about 1% to about 60% by weight based on the weight of the mixed herbal powder.

8. The process of claim 1, wherein asparagus is present in an amount from about 1% to about 60% by weight based on the weight of the mixed herbal powder.

9. The process of claim 1, wherein mushroom is present in an amount from about 1% to about 60% by weight based on the weight of the mixed herbal powder.

10. The process of claim 1, wherein the process further comprises increasing the temperature of the extraction process from about 30° C. to about 100° C.

11. The process of claim 1, wherein the extraction time further comprises increasing the extraction time from about 1 hour to 3 hours.

12. The process of claim 1, wherein the drying of the herbal extract is performed by spray-drying.

13. The process of claim 12, wherein the drying of the herbal extract is coupled to a fluidized bed.

14. A process for preparing a herbal composition comprises a mixture of herbal materials, wherein the mixture of herbal materials comprises Panax ginseng, Glycyrrhiza uralensis, Agrimonia pilosa, Gynostemma pentaphyllum, asparagus and mushroom, the process comprising:
a. pulverizing herbal materials;
b. combining the pulverized herbal materials to obtain a mixed herbal powder;
c. extracting the mixed herbal powder with a solvent at a temperature from about 40° C. to about 70° C. for a period of time from about 1.5 hours to 2.5 hours to obtain a herbal extract;
d. concentrating the herbal extract to obtain a concentrated herbal liquid, wherein the concentrated herbal liquid has a density of from about 0.8 g/cm³ to about 1.5 g/cm³;
e. loading the concentrated herbal liquid on a fluidized bed; and
f. spray drying the herbal liquid to obtain the herbal composition.

15. The process of claim 14, wherein the mixture of herbal materials comprises:
a. from about 1% to about 60% of ginseng by weight;
b. from about 1% to about 60% of Glycyrrhiza uralensis by weight;
c. from about 1% to about 60% of Agrimonia pilosa by weight;
d. from about 1% to about 60% of Gynostemma pentaphyllum by weight;
e. from about 1% to about 60% of asparagus by weight; and
f. from about 1% to about 60% of mushroom by weight;
g. wherein all of which are based on the weight of the mixed herbal powder.

16. The process of claim 14, wherein the mixture of herbal materials comprises:
a. from about 10% to about 40% of Panax ginseng by weight;
b. from about 10% to about 40% of Glycyrrhiza uralensis by weight;
c. from about 1% to about 40% of Agrimonia pilosa by weight;
d. from about 5% to about 35% of Gynostemma pentaphyllum by weight;
e. from about 10% to about 40% of asparagus by weight; and
f. from about 1% to about 40% of mushroom by weight;
g. wherein all of which are based on the weight of the mixed herbal powder.

17. The process of claim 14, wherein the mixture of herbal materials comprises:
a. from about 15% to about 25% of Panax ginseng by weight;
b. from about 15% to about 25% of Glycyrrhiza uralensis by weight;
c. from about 1% to about 30% of Agrimonia pilosa by weight;
d. from about 10% to about 25% of Gynostemma pentaphyllum by weight;
e. from about 15% to about 25% of asparagus by weight; and
f. from about 1% to about 10% of mushroom by weight;
g. wherein all of which are based on the weight of the mixed herbal powder.

18. A composition of herbal extract prepared by the process of claim 1.
